(19) United States
(12) Patent Application Publication
(10) Pub. No.: US 2019/0197472 A1
(43) Pub. Date: Jun. 27, 2019

(54) SERVER DEVICE AND VEHICLE DISPATCHING METHOD

(71) Applicant: Toyota Jidosha Kabushiki Kaisha, Toyota-shi Aichi-ken (JP)

(72) Inventors: Tomohito Matsuoka, Nagoya-shi Aichi-ken (JP); Seiichi Tsunoda, Nisshin-shi Aichi-ken (JP); Jiro Goto, Seto-shi Aichi-ken (JP); Masayuki Yamada, Chofu-shi Tokyo-to (JP); Yasutaka Eto, Okazaki-shi Aichi-ken (JP); Keima Fukunaga, Toyota-shi Aichi-ken (JP)

(21) Appl. No.: 16/222,199

(22) Filed: Dec. 17, 2018

(30) Foreign Application Priority Data
Dec. 26, 2017 (JP) 2017-250047

(51) Int. Cl. G06Q 10/08

(52) U.S. Cl. CPC G06Q 10/0834

(57) ABSTRACT

In a server device, an acquisition unit acquires information on the amount and respective delivery areas of a plurality of packages collected at a relay point, the packages are sorted at the relay point. A dispatch unit dispatches, for each delivery area, a vehicle of a size corresponding to the amount of packages for the delivery area to the relay point, based on the information on the amount and respective delivery areas of the plurality of packages acquired by the acquisition unit, before the plurality of packages are collected at the relay point.

### CROSS-REFERENCE TO RELATED APPLICATION

This application claims priority to Japanese Patent Application No. 2017-250047 filed on Dec. 26, 2017, incorporated herein by reference in its entirety.

### BACKGROUND

### 1. Technical Field

The present disclosure relates to server devices that control vehicles and a vehicle dispatching method.

### 2. Description of Related Art

A technology is known where a small vehicle is dispatched when a package assigned to a temporarily-dispatched vehicle can be loaded in a vehicle that is smaller than the temporarily-dispatched vehicle at the time of shipping the package (see, for example, JP-A-2010-168205).

In the above technology, it takes a long time to start delivery since a small vehicle is dispatched after temporarily dispatching a vehicle so as to start the delivery.

### SUMMARY

In this background, a purpose of the present disclosure is to provide a server device and a vehicle dispatching method that allow a vehicle of a proper size to start delivery in a short time.

A server device according to one embodiment of the present disclosure includes: an acquisition unit configured to acquire information on the amount and respective delivery areas of a plurality of packages collected at a relay point, the packages being sorted at the relay point; and a dispatch unit configured to dispatch, for each delivery area, a vehicle of a size corresponding to the amount of packages for the delivery area to the relay point, based on the information on the amount and respective delivery areas of the plurality of packages acquired by the acquisition unit, before the plurality of packages are collected at the relay point.

According to this embodiment, for each delivery area, a vehicle of a size corresponding to the amount of packages for the delivery area is dispatched to the relay point before a plurality of packages are collected at the relay point, and a vehicle of a proper size can thus start delivery in a short time.

The plurality of packages may all have the same size, and the acquisition unit may acquire information on the number of the plurality of packages as information on the amount of the plurality of packages.

The size of each package may be a basic size or the size of a plurality of packages of the basic size that are arranged side by side, and the acquisition unit may acquire information on the number and respective sizes of the plurality of packages as information on the amount of the plurality of packages.

Another embodiment of the present disclosure relates to a vehicle dispatching method. This method includes: acquiring information on the amount and respective delivery areas of a plurality of packages collected at a relay point, the packages being sorted at the relay point; and dispatching, for each delivery area, a vehicle of a size corresponding to the amount of packages for the delivery area to the relay point, based on the information on the amount and respective delivery areas of the plurality of packages that has been acquired, before the plurality of packages are collected at the relay point.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram explaining the sorting of packages to a plurality of vehicles at a relay point according to a first embodiment;

FIG. 2 is a block diagram of a vehicle system including the vehicles of FIG. 1;

FIG. 3 is a block diagram illustrating the configuration of a server device of FIG. 2;

FIG. 4 is a block diagram illustrating the configuration of a vehicle-mounted device of FIG. 2; and

FIG. 5 is a perspective view illustrating an example of a plurality of packages according to a second embodiment.

### DETAILED DESCRIPTION

Embodiments will now be described. The embodiments are illustrative and are not intended to be limiting.

### First Embodiment

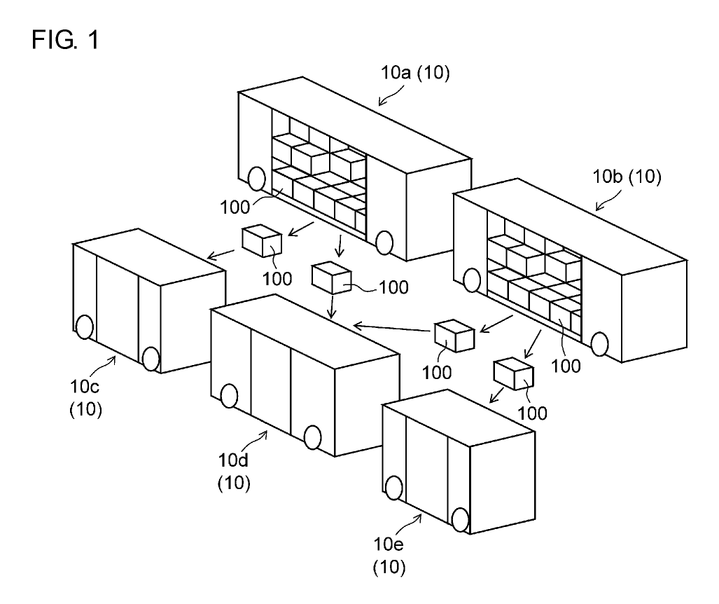

FIG. 1 is a diagram explaining the sorting of packages to a plurality of vehicles 10 at a relay point according to a first embodiment. The relay point is also referred to as a distribution center. At the relay point, a first vehicle 10a, a second vehicle 10b, a third vehicle 10c, a fourth vehicle 10d, and a fifth vehicle 10e, which are collectively referred to as vehicles 10, are parked. The number of the vehicles 10 is not particularly limited. The vehicles 10 are automatically-driven vehicles. The vehicles 10 are, for example, electric-powered vehicles but are not particularly limited.

The first vehicle 10a and the second vehicle 10b are vehicles that have arrived at the relay point after loading a plurality of packages 100 from the place of shipment. The plurality of packages 100 all have the same size. An IC tag (not shown in the figures) is attached to each of the packages 100. The IC tag holds information on the destination of the package 100 to which the IC tag is attached.

Packages 100 loaded in the first vehicle 10a and the second vehicle 10b are sorted into the third vehicle 10c, the fourth vehicle 10d, and the fifth vehicle 10e at the relay point for each delivery area. A delivery area is an area for delivering packages 100 using one vehicle 10 and includes one or more destinations.

At the time of the sorting, packages 100 may be loaded into the vehicles 10 in order starting with those with farther destination for each delivery area. Further, as the destination of a package 100 becomes farther away, the package 100 may be loaded toward the back of the vehicle 10, and as the destination of a package 100 becomes closer, the package 100 may be loaded toward the front of the vehicle 10. This makes it easier to take out the packages 100 from the vehicle 10 when delivering the packages 100 in order starting with a package 100 with the closest destination.

The sorting may be carried out by a worker or may be carried out by a cart that is capable of transporting the packages 100 automatically after loading the packages 100. This cart is provided with a robot arm that reads the information of an IC tag and automatically loads and unloads the packages 100 based on the information that has been read.

After the packages 100 are loaded, the third vehicle 10c, the fourth vehicle 10d, and the fifth vehicle 10e deliver the packages 100 to different delivery areas, respectively. For example, the delivery area of the third vehicle 10c is a convenience store. In this case, the delivery area may include destinations indicating one or more convenience stores. For example, the delivery area of the fourth vehicle 10d is a mid-size city, and the delivery area of the fifth vehicle 10e is a small village.

The size of the first vehicle 10a and the size of the second vehicle 10b are large. The size of the fourth vehicle 10d is smaller than the size of the first vehicle 10a and is a medium size. The size of the third vehicle 10c and the size of the fifth vehicle 10e are smaller than the size of the fourth vehicle 10d and are compact. The respective sizes of the vehicles 10 are not limited to the three types.

As will be described later, before the first vehicle 10a and the second vehicle 10b arrive at the relay point, that is, before a plurality of packages 100 are collected at the relay point, the third vehicle 10c, the fourth vehicle 10d, and the fifth vehicle 10e of sizes respectively corresponding to the number of packages 100 for respective delivery areas are dispatched to the relay point on a delivery area to delivery area basis.

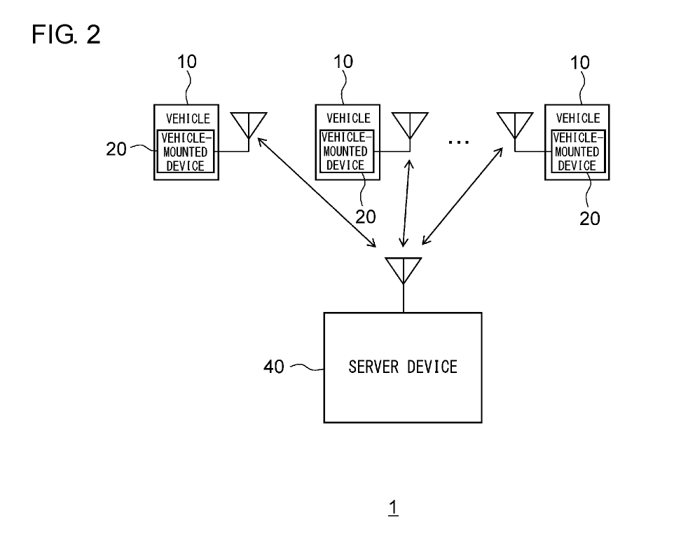

FIG. 2 is a block diagram of a vehicle system 1 including the vehicles 10 of FIG. 1. The vehicle system 1 includes a plurality of vehicle-mounted devices 20 and a server device 40. In FIG. 2, three vehicle-mounted devices 20 among the plurality of vehicle-mounted devices 20 are illustrated.

The vehicle-mounted device 20 is mounted in the vehicle 10. The vehicle-mounted device 20 performs wireless communication with the server device 40. Although the standard of the wireless communication is not particularly limited, the standard includes, for example, wireless LAN, 3G (third generation mobile communication system), 4G (fourth generation mobile communication system) or 5G (fifth generation mobile communication system). The vehicle-mounted device 20 may perform wireless communication with the server device 40 via a base station (not shown).

The server device 40 is arranged, for example, at the relay point. The server device 40 controls the vehicles 10. The server device 40 may be arranged in a data center or the like.

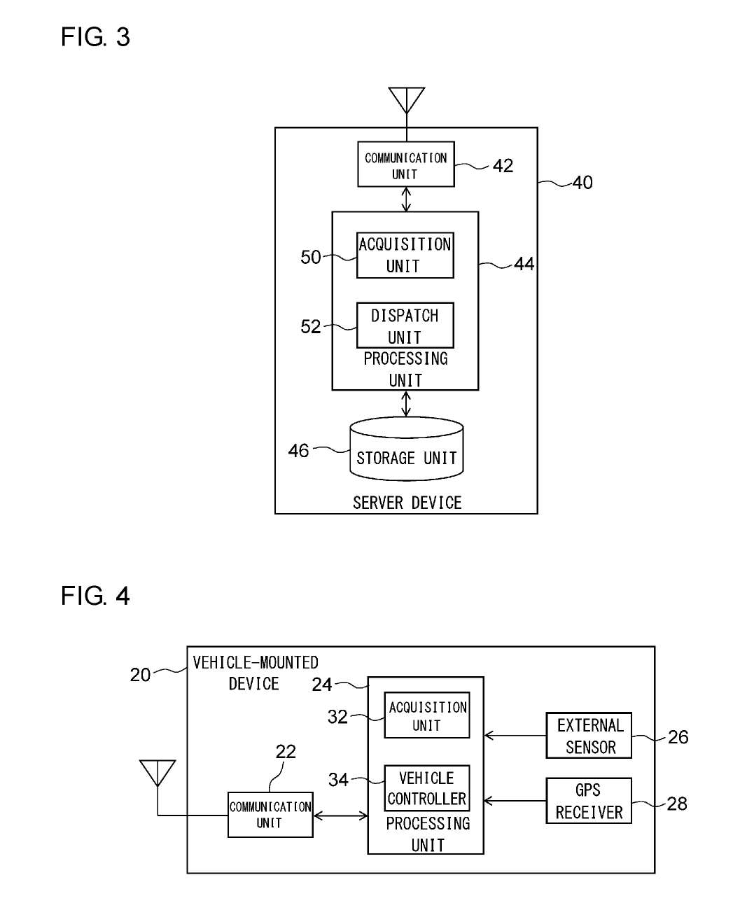

FIG. 3 is a block diagram illustrating the configuration of the server device 40 of FIG. 2. The server device 40 includes a communication unit 42, a processing unit 44, and a storage unit 46. The processing unit 44 includes an acquisition unit 50 and a dispatch unit 52.

The communication unit 42 performs wireless communication with a plurality of vehicle-mounted devices 20. Before the first vehicle 10a and the second vehicle 10b arrive at the relay point, the communication unit 42 receives information on the amount and destinations of a plurality of packages 100 collected at the relay point in a predetermined time period. More specifically, the communication unit 42 acquires information on the number of the plurality of packages 100 as information on the amount of the plurality of packages 100. For example, the respective vehicle-mounted devices 20 of the first vehicle 10a and the second vehicle 10b acquire information on the destinations and the number of packages 100 from IC tags attached to the respective packages 100 loaded at the shipping place and transmit this information to the server device 40. Alternatively, a terminal device at the shipping place may acquire the Information on the destinations and the number of the packages 100 from IC tags attached to the packages 100 loaded in the first vehicle 10a and the second vehicle 10b at the shipping location and transmit the information to the server device 40. The predetermined time period is a time period before the time when the third vehicle 10c, the fourth vehicle 10d, and the fifth vehicle 10e should depart from the relay point toward each destination.

The storage unit 46 stores a relationship between a plurality of destinations and delivery areas including each destination. The storage unit 46 stores the respective sizes of the plurality of vehicles 10.

The acquisition unit 50 acquires the information on the destinations and the number of the plurality of packages 100 received by the communication unit 42. The acquisition unit 50 acquires information on the delivery areas of the plurality of packages 100 based on the information stored in the storage unit 46 and the destinations of the plurality of packages 100. The IC tags attached to the packages 100 may hold the information on the delivery areas instead of or in addition to the destinations of the packages 100. In this case, the communication unit 42 receives the information on the delivery areas of the plurality of packages 100, and the acquisition unit 50 acquires the information on the delivery areas of the plurality of packages 100 received by the communication unit 42.

Before a plurality of packages 100 are collected at the relay point, the dispatch unit 52 dispatches, for each delivery area, a vehicle 10 of a size corresponding to the number of packages 100 for the delivery area to the relay point, via the communication unit 42, based on the information acquired by the acquisition unit 50 and the respective sizes of the plurality of vehicles 10 stored in the storage unit 46. More specifically, for each delivery area, the dispatch unit 52 determines the size of a vehicle 10 for the delivery area according to the number of packages 100 for the delivery area and derives a travel instruction that causes the vehicle 10 of the determined size to automatically travel to the relay point. The travel instruction for travelling to the relay point includes positional information for the relay point. The positional information includes latitude and longitude. Since the packages 100 have the same size, the size of the vehicle 10 can be appropriately determined based on the number of packages 100 in the delivery area so that wasted space is reduced.

The communication unit 42 transmits to the target vehicle 10 the travel instruction for travelling to the relay point derived by the dispatch unit 52 and the destinations of the plurality of packages 100 in the delivery area acquired by the acquisition unit 50. Information for identifying the vehicle 10 at the destination of the transmission is attached to the travel instruction and the like. The target vehicle 10 is, for example, an unoccupied vehicle on standby at a standby place near the relay point, and, in the example of FIG. 1, the target vehicle 10 is the third vehicle 10c, the fourth vehicle 10d, or the fifth vehicle 10e.

FIG. 4 is a block diagram illustrating the configuration of a vehicle-mounted device 20 of FIG. 2. The vehicle-mounted device 20 includes a communication unit 22, a processing unit 24, an external sensor 26, and a GPS receiver 28. The processing unit 24 includes an acquisition unit 32 and a vehicle controller 34.

The communication unit 22 performs wireless communication with the server device 40. When information such as a travel, instruction for travelling to the relay point is transmitted from the server device 40 to the own vehicle, the communication unit 22 receives this information.

The external sensor 26 periodically detects information on obstacles such as pedestrians around the own vehicle and outputs the detection result to the processing unit 24. The external sensor 26 includes, for example, at least one of a camera, a lidar (LIDAR: Laser Imaging Detection and Ranging), and a radar.

The GPS receiver 28 receives a signal from a GPS satellite and derives the position and direction of the own vehicle. The position includes latitude and longitude. The GPS receiver 28 outputs information on the position and direction of the own vehicle to the processing unit 24.

The acquisition unit 32 acquires information such as a travel instruction for travelling to the relay point received by the communication unit 22. The acquisition unit 32 acquires a first travelling route from the current position to the relay point, based on the travel instruction for travelling to the relay point, the position of the own vehicle, and map information stored in a storage unit (not shown). Further, the acquisition unit 32 acquires a second travelling route passing through the respective destinations of the plurality of packages 100 from the relay point, based on the respective destinations of the plurality of packages 100 and the map information stored in the storage unit (not shown). A publicly-known route search technology can be used for the acquisition of the first and second travelling routes.

When the travel instruction for travelling to the relay point is acquired by the acquisition unit 32, the vehicle controller 34 controls a driving motor, a braking device, a steering device, and the like (not shown) according to the first travelling route and the information on the position and direction of the own vehicle so as to cause the own vehicle to automatically travel along the first travelling route. When there is no obstacle in the traveling direction based on the information on obstacles around the own vehicle detected by the external sensor 26, the vehicle controller 34 moves the own vehicle. For such control, a well-known automatic driving technology can be used.

When the position of the own vehicle reaches the relay point acquired by the acquisition unit 32, the vehicle controller 34 parks the own vehicle. As described above, the packages 100 are loaded inside the vehicle 10 at the relay point.

When the packages 100 are loaded inside the vehicle 10 at the relay point, the vehicle controller 34 causes the own vehicle to travel along the second travelling route in accordance with the second travelling route and the information on the position and direction of the own vehicle. When the position of the own vehicle reaches the destination position of a package 100, the vehicle controller 34 stops the own vehicle. At the destination, the cart mounted in the vehicle 10 may take out a package 100 from the vehicle 10 using a robot arm and transport the package 100 to a predetermined position, or the person at the destination may take out the package 100 from the vehicle 10. The delivery person may drive the vehicle 10 and deliver a package 100 from the relay point to each destination.

The configuration is implemented in hardware by any CPU of a computer, memory or other LSI's, and in software by a program or the like loaded into the memory. The figure depicts functional blocks implemented by the cooperation of hardware and software. Thus, a person skilled in the art should appreciate that there are many ways of accomplishing these functional blocks in various forms in accordance with the components of hardware only, software only, or the combination of both.

As described above, according to the present embodiment, for each delivery area, a vehicle 10 of a size corresponding to the number of packages 100 in the delivery area is dispatched to the relay point before a plurality of packages 100 are collected at the relay point, allowing a vehicle 10 of a proper size to start delivery in a short time.

Further, since the respective sizes of the plurality of packages 100 are equal to one another, the size of the vehicle 10 to be dispatched can be easily and appropriately determined based on the number of packages 100 in the delivery area.

### Second Embodiment

A second embodiment is different from the first embodiment in that packages 100 of a plurality of sizes are handled. An explanation will be given in the following mainly regarding differences from the first embodiment.

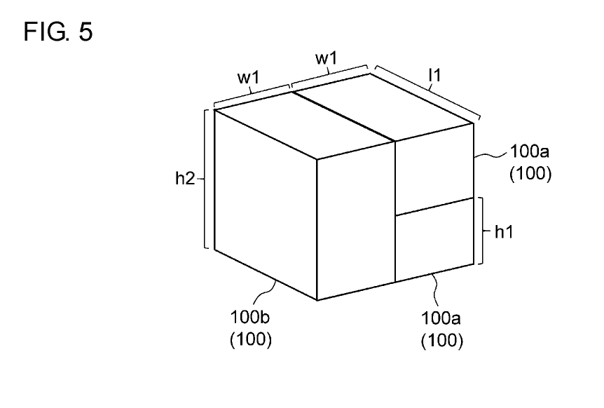

FIG. 5 is a perspective view illustrating an example of a plurality of packages 100 according to the second embodiment. The size of each package 100 collected at a relay point is a basic size ox the size of a plurality of vertically or horizontally arranged packages 100a of the basic size. The size of a package 100b is the size of two vertically arranged packages 100a of the basic size. The basic size is represented by height h1, length 11, and width w1. The size of the package 100b is represented by height h2, length 11, and width w1. The height h2 is twice the height h1. The size of each package 100 is not limited to the two types. Such sizes allow a plurality of packages 100 to be loaded into a vehicle 10 while being in close contact with one another, and wasted space is thus hard to be created.

An IC tag attached to each package 100 holds information on the destination and size of the package 100 to which the IC tag is attached. The information on the size is information indicating how many times more the size is compared to the basic size. The IC tag may hold information on the delivery area of the package 100 to which the IC tag is attached.

Since the configurations of the vehicle system 1, the server device 40, and the vehicle-mounted device 20 are the same as those in FIGS. 2 to 4, illustration thereof is omitted. In the server device 40, in addition to information on the respective destinations of a plurality of packages 100 collected at the relay point in a predetermined time period, the communication unit 42 receives Information on the number and sizes of the plurality of packages 100 as information on the amount of the plurality of packages 100. The acquisition unit 50 acquires information on the destinations, the number, and the sizes of the plurality of packages 100.

Before the plurality of packages 100 are collected at the relay point, for each delivery area, the dispatch unit 52 dispatches to the relay point a vehicle 10 of a size corresponding to the number and sizes of packages 100 for the delivery area. More specifically, for each delivery area, the dispatch unit 52 determines the size of a vehicle 10 for the delivery area according to the number and sizes of packages 100 for the delivery area and derives a travel instruction that causes the vehicle 10 of the determined size to automatically travel to the relay point.

As described above, according to the present embodiment, the size of each package 100 is the basic size or the size of a plurality of packages 100 of the basic size that are arranged side by side, and, for each delivery area, a vehicle 10 of a size corresponding to the number and sizes of packages 100 for the delivery area is dispatched to the relay point; thus, it is possible to deal with the packages 100 of a plurality of sizes, and a vehicle 10 that has a proper size can be dispatched.

Described above is an explanation based on exemplary embodiments. The embodiments are intended to be illustrative only, and it will be obvious to those skilled in the art that various modifications to a combination of constituting elements or processes could be developed and that such modifications also fall within the scope of the present disclosure.

For example, the acquisition unit 32 of the vehicle-mounted device 20 may acquire a travelling route based on road information. The road information includes the position of a road closure and the time required until the road closure is removed. The vehicle-mounted device 20 can acquire such road information from a different server (not shown) using wired communication or wireless communication. The different server acquires information on the time required until the road closure is removed, which has been entered by the worker, and the position of road closure from, e.g., a terminal device possessed by the worker. The position of the road closure includes, for example, a position where construction is going on, a position where accident processing is going on, a position where signal trouble is happening, a position where a falling object is being removed, a position where a fallen tree is being handled, and the like.

When the vehicle 10 is expected to arrive at the position of a road closure before the passing of the time required until the road closure is removed based on the speed of the vehicle 10, the acquisition unit 32 acquires a travelling route that does not pass through the position of the road closure. When the vehicle is expected to arrive at the position of the road closure after the passing of the time required until the road closure is removed, the acquisition unit 32 acquires a travelling route that passes through the position of the road closure if the travelling route that passes through the position of the road closure is the shortest.

According to this exemplary variation, the vehicle 10 can travel on an appropriate traveling route even when there are roads that are closed.

Further, in the first embodiment, the third vehicle 10c, the fourth vehicle 10d, and the fifth vehicle 10e may each carry a package 100 including vehicle parts. The size of the package 100 including the vehicle parts is also equal to the size of the other packages 100. The vehicle parts are parts of a vehicle 10 and include, for example, a battery, a power unit, a steering device, and the like. The vehicle parts are used, for example, to replace failed parts in case of failure of the vehicle 10. In this exemplary variation, it is possible to easily deal with failure of the vehicle 10 while appropriately determining the size of the vehicle 10 so as to reduce wasted space.

Further, when a package 100 is designated with a delivery date, the IC tag attached to this package 100 may hold information on the designated delivery date. In this case, the communication unit 42 of the server device 40 also receives information on the respective designated delivery dates of a plurality of packages 100 collected at the relay point. The acquisition unit 50 also acquires the information on the respective designated delivery dates of the plurality of packages 100. For each delivery area, the dispatch unit 52 dispatches to the relay point a vehicle 10 of a size corresponding to the number and sizes of packages 100 for the delivery area, excluding packages 100 whose designated delivery date is later than the date of the delivery. The packages 100 whose designated delivery date is later than the date of the delivery performed by the vehicle 10 that has been dispatched are not loaded into the vehicle 10 that has been dispatched. In this exemplary variation, even in a case where a delivery date is designated for a package 100, it is possible to appropriately deal with the case.

Further, a vehicle 10 that carries and transports a plurality of packages 100 to the relay point from the shipping place may not be an automatically-driven vehicle and may be driven by a driver.

What is claimed is:

1. A server device comprising;
an acquisition unit configured to acquire information on the amount and respective delivery areas of a plurality of packages collected at a relay point, the packages being sorted at the relay point; and
a dispatch unit configured to dispatch, for each delivery area, a vehicle of a size corresponding to the amount of packages for the delivery area to the relay point, based on the information on the amount and respective delivery areas of the plurality of packages acquired by the acquisition unit, before the plurality of packages are collected at the relay point.

2. The server device according to claim 1,
wherein the plurality of packages all have the same size, and
wherein the acquisition unit acquires information on the number of the plurality of packages as information on the amount of the plurality of packages.

3. The server device according to claim 1,
wherein the size of each package is a basic size or the size of a plurality of packages of the basic size that are arranged side by side, and
wherein the acquisition unit acquires information on the number and respective sizes of the plurality of packages as information on the amount of the plurality of packages.

4. A vehicle dispatching method comprising:
acquiring information on the amount and respective delivery areas of a plurality of packages collected at a relay point, the packages being sorted at the relay point; and
dispatching, for each delivery area, a vehicle of a size corresponding to the amount of packages for the delivery area to the relay point, based on the information on the amount and respective delivery areas of the plurality of packages that has been acquired, before the plurality of packages are collected at the relay point.
